(19) United States
(12) Patent Application Publication
(10) Pub. No.: US 2023/0239779 A1
(43) Pub. Date: Jul. 27, 2023

(54) INTERWORKING FUNCTION SELECTION ACCOUNTING FOR SUPPORTED NETWORK SLICES

(71) Applicant: QUALCOMM Incorporated, San Diego, CA (US)

(72) Inventors: Sebastian Speicher, Wallisellen (CH); Stefano Faccin, San Ysidro, CA (US)

(21) Appl. No.: 18/153,290

(22) Filed: Jan. 11, 2023

Related U.S. Application Data
(60) Provisional application No. 63/303,406, filed on Jan. 26, 2022.

(51) Int. Cl. H04W 48/18; H04W 60/04

(52) U.S. Cl. CPC H04W 48/18; H04W 60/04

(57) ABSTRACT

Methods, systems, and devices for wireless communications are described. A public land mobile network (PLMN) may indicate to a user equipment (UE) which network slices are supported by available non-Third Generation Partnership Program (3GPP) interworking functions (N3IWF). The PLMN may provide, to the UE, non-3GPP access node (N3AN) selection information that indicates a set of N3IWFs and a set of supported network slices. The network slices may be indicated via Network Slice Simultaneous Registration Group (NSSRGs) associated with each N3IWF. If a UE is not configured to support NSSRGs, the PLMN may indicate network slices that may be used concurrently and may indicate one or more N3IWFs that support the indicated network slices. The UE may select an N3IWF based on one or more selected network slices. The UE may register with the N3IWF and connect to the N3AN based on an internet protocol address associated with the N3IWF.

### CROSS REFERENCE

The present application for patent claims the benefit of U.S. Provisional Patent Application No. 63/303,406 by SPEICHER et al., entitled “INTERWORKING FUNCTION SELECTION ACCOUNTING FOR SUPPORTED NETWORK SLICES,” filed Jan. 26, 2022, assigned to the assignee hereof, and expressly incorporated by reference herein.

### FIELD OF TECHNOLOGY

The following relates to wireless communications, including interworking function selection accounting for supported network slices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support interworking function (IWF) selection accounting for supported network slices. Generally, the described techniques provide for selection of IWFs based on selected and supported network slices.

A user equipment (UE) may connect with a non-Third Generation Partnership Program (3GPP) access network (N3AN) via a non-3GPP interworking function (N3IWF). A serving base station, base station component, or other network node associated with a public land mobile network (PLMN) may indicate to a UE which network slices are supported by available N3IWFs. N3AN node selection information provided by a PLMN to a UE may indicate a set of N3IWFs and a set of network slices supported by each N3IWF. The UE may select an N3IWF based on one or more selected network slices. The UE may register with the N3IWF and connect to the N3AN based on an internet protocol address (IP) associated with the N3IWF.

A method for wireless communications at a user equipment (UE) is described. The method may include receiving a control message including an access network node configuration, the access network node configuration indicating a set of IWFs and a set of network slices associated with the set of IWFs, selecting an IWF from the set of IWFs based on a target network slice being indicated in the access network node configuration as associated with the selected IWF, and transmitting a registration message to the selected IWF.

An apparatus for wireless communications at a UE is described. The apparatus may include a processor, memory coupled with the processor, and instructions stored in the memory. The instructions may be executable by the processor to cause the apparatus to receive a control message including an access network node configuration, the access network node configuration indicating a set of IWFs and a set of network slices associated with the set of IWFs, select an IWF from the set of IWFs based on a target network slice being indicated in the access network node configuration as associated with the selected IWF, and transmit a registration message to the selected IWF.

Another apparatus for wireless communications at a UE is described. The apparatus may include means for receiving a control message including an access network node configuration, the access network node configuration indicating a set of IWFs and a set of network slices associated with the set of IWFs, means for selecting an IWF from the set of IWFs based on a target network slice being indicated in the access network node configuration as associated with the selected IWF, and means for transmitting a registration message to the selected IWF.

A non-transitory computer-readable medium storing code for wireless communications at a UE is described. The code may include instructions executable by a processor to receive a control message including an access network node configuration, the access network node configuration indicating a set of IWFs and a set of network slices associated with the set of IWFs, select an IWF from the set of IWFs based on a target network slice being indicated in the access network node configuration as associated with the selected IWF, and transmit a registration message to the selected IWF.

Some examples of the method, apparatuses, and non-transitory computer-readable medium described herein may further include operations, features, means, or instructions for selecting the IWF based on the selected IWF being associated with a network slice simultaneous registration group including the target network slice, where the access network node configuration indicates a set of network slice simultaneous registration groups associated with each IWF of the set of IWFs.

Some examples of the method, apparatuses, and non-transitory computer-readable medium described herein may further include operations, features, means, or instructions for selecting a second target network slice for concurrent use with the target network slice, selecting, based on determining that the IWF may be not associated with the second target network slice, a second IWF of the set of IWFs, the second IWF associated with the target network slice and the second target network slice, and transmitting a second registration message indicating the selected second IWF.

Some examples of the method, apparatuses, and non-transitory computer-readable medium described herein may further include operations, features, means, or instructions for transmitting a name resolution request message indicating the selected IWF and receiving, in response to the name resolution request message, an indication of an internet protocol address associated with the selected IWF, where the registration message may be based on the internet protocol address associated with the selected IWF.

Some examples of the method, apparatuses, and non-transitory computer-readable medium described herein may further include operations, features, means, or instructions for receiving, with the access network node configuration, an indication to add a slicing prefix to name resolution request message and transmitting, with the name resolution request message, a selected slicing prefix associated with the target network slice.

Some examples of the method, apparatuses, and non-transitory computer-readable medium described herein may further include operations, features, means, or instructions for receiving, with the access network node configuration, an indication of prefix mapping information indicating a set of network slice simultaneous registration groups and an associated set of slicing prefixes and selecting the selected slicing prefix based on the network slice simultaneous registration group associated with the selected slicing prefix being associated with the target network slice.

Some examples of the method, apparatuses, and non-transitory computer-readable medium described herein may further include operations, features, means, or instructions for receiving the indication to add the slicing prefix to the name resolution request message includes receiving the indication of prefix mapping information.

Some examples of the method, apparatuses, and non-transitory computer-readable medium described herein may further include operations, features, means, or instructions for receiving a second control message indicating a second set of network slices and selecting the target network slice from the second set of network slices based on a target communication function.

In some examples of the method, apparatuses, and non-transitory computer-readable medium described herein, receiving the second control message may include operations, features, means, or instructions for receiving the second control message in a mobility management message.

Some examples of the method, apparatuses, and non-transitory computer-readable medium described herein may further include operations, features, means, or instructions for receiving, with the second control message, an indication of prefix mapping information indicating a set of network slice simultaneous registration groups and an associated set of slicing prefixes and transmitting, with a name resolution request, a selected slicing prefix indicating a network slice simultaneous registration group associated with the target network slice based on the indication of the prefix mapping information.

In some examples of the method, apparatuses, and non-transitory computer-readable medium described herein, the set of network slices may be used concurrently by the UE, and the set of IWFs may be associated with the set of network slices that may be used concurrently.

Some examples of the method, apparatuses, and non-transitory computer-readable medium described herein may further include operations, features, means, or instructions for receiving, from a home network, an indication of access network node selection information for a roaming network, the access network node selection information indicating prefix mapping information indicating a set of network slice simultaneous registration groups and an associated set of slicing prefixes for the roaming network, receiving, from the roaming network, a second control message, and transmitting, with a name resolution request message, a selected slicing prefix indicating a network slice simultaneous registration group associated with the target network slice based on the indication of the prefix mapping information.

Some examples of the method, apparatuses, and non-transitory computer-readable medium described herein may further include operations, features, means, or instructions for receiving the control message as a non-access stratum message.

Some examples of the method, apparatuses, and non-transitory computer-readable medium described herein may further include operations, features, means, or instructions for transmitting the registration message to the selected IWF based on an internet protocol address associated with the IWF, where the access network node configuration indicates a respective internet protocol address associated with each IWF of the set of IWFs.

A method for wireless communications at a network device is described. The method may include transmitting, to a UE, a control message including an access network node configuration, the access network node configuration indicating a set of IWFs and a set of network slices associated with the set of IWFs and receiving, from the UE, a name resolution request message indicating a selected IWF based on the access network node configuration.

An apparatus for wireless communications at a network device is described. The apparatus may include a processor, memory coupled with the processor, and instructions stored in the memory. The instructions may be executable by the processor to cause the apparatus to transmit, to a UE, a control message including an access network node configuration, the access network node configuration indicating a set of IWFs and a set of network slices associated with the set of IWFs and receive, from the UE, a name resolution request message indicating a selected IWF based on the access network node configuration.

Another apparatus for wireless communications at a network device is described. The apparatus may include means for transmitting, to a UE, a control message including an access network node configuration, the access network node configuration indicating a set of IWFs and a set of network slices associated with the set of IWFs and means for receiving, from the UE, a name resolution request message indicating a selected IWF based on the access network node configuration.

A non-transitory computer-readable medium storing code for wireless communications at a network device is described. The code may include instructions executable by a processor to transmit, to a UE, a control message including an access network node configuration, the access network node configuration indicating a set of IWFs and a set of network slices associated with the set of IWFs and receive, from the UE, a name resolution request message indicating a selected IWF based on the access network node configuration.

Some examples of the method, apparatuses, and non-transitory computer-readable medium described herein may further include operations, features, means, or instructions for transmitting, with the access network node configuration, a set of network slice simultaneous registration groups associated with each IWF of the set of IWFs.

Some examples of the method, apparatuses, and non-transitory computer-readable medium described herein may further include operations, features, means, or instructions for transmitting, to the UE, in response to the name resolution request message, an indication of an internet protocol address associated with the selected IWF.

Some examples of the method, apparatuses, and non-transitory computer-readable medium described herein may further include operations, features, means, or instructions for transmitting, with the access network node configuration, an indication to add a slicing prefix to the name resolution request message and receiving, with the name resolution request message, a selected slicing prefix indicating a target network slice.

Some examples of the method, apparatuses, and non-transitory computer-readable medium described herein may further include operations, features, means, or instructions for transmitting, with the access network node configuration, an indication of prefix mapping information indicating a set of network slice simultaneous registration groups and an associated set of slicing prefixes, where the selected slicing prefix may be based on the network slice simultaneous registration group associated with the selected slicing prefix being associated with the target network slice.

Some examples of the method, apparatuses, and non-transitory computer-readable medium described herein may further include operations, features, means, or instructions for transmitting the indication to add the slicing prefix to the name resolution request message includes receiving the indication of prefix mapping information.

Some examples of the method, apparatuses, and non-transitory computer-readable medium described herein may further include operations, features, means, or instructions for transmitting, to the UE, an access and mobility message indicating a second set of network slices.

Some examples of the method, apparatuses, and non-transitory computer-readable medium described herein may further include operations, features, means, or instructions for transmitting, with the access and mobility message, an indication of prefix mapping information indicating a set of network slice simultaneous registration groups and an associated set of slicing prefixes and receiving, with the name resolution request message, a selected slicing prefix indicating a network slice simultaneous registration group associated with a target network slice based on the indication of the prefix mapping information.

In some examples of the method, apparatuses, and non-transitory computer-readable medium described herein, the set of network slices may be used concurrently by the UE, and the set of IWFs may be associated with the set of network slices that may be used concurrently.

Some examples of the method, apparatuses, and non-transitory computer-readable medium described herein may further include operations, features, means, or instructions for transmitting the control message as a non-access stratum message.

### BRIEF DESCRIPTION OF THE DRAWINGS

FIG. 1 illustrates an example of a wireless communications system that supports interworking function (IWF) selection accounting for supported network slices in accordance with aspects of the present disclosure.

FIG. 2 illustrates an example of a wireless communications system that supports IWF selection accounting for supported network slices in accordance with aspects of the present disclosure.

FIG. 3 illustrates an example of a process flow that supports IWF selection accounting for supported network slices in accordance with aspects of the present disclosure.

FIGS. 4 and 5 show block diagrams of devices that support IWF selection accounting for supported network slices in accordance with aspects of the present disclosure.

FIG. 6 shows a block diagram of a communications manager that supports IWF selection accounting for supported network slices in accordance with aspects of the present disclosure.

FIG. 7 shows a diagram of a system including a device that supports IWF selection accounting for supported network slices in accordance with aspects of the present disclosure.

FIGS. 8 and 9 show block diagrams of devices that support IWF selection accounting for supported network slices in accordance with aspects of the present disclosure.

FIG. 10 shows a block diagram of a communications manager that supports IWF selection accounting for supported network slices in accordance with aspects of the present disclosure.

FIG. 11 shows a diagram of a system including a device that supports IWF selection accounting for supported network slices in accordance with aspects of the present disclosure.

FIGS. 12 through 17 show flowcharts illustrating methods that support IWF selection accounting for supported network slices in accordance with aspects of the present disclosure.

### DETAILED DESCRIPTION

In some wireless communication systems, a user equipment (UE) may register with and connect to a public land mobile network (PLMN). The network may be associated with a geographic region (e.g., a country) covered by a mobile operator to provide various wireless communication services (e.g., voice and data services) to mobile subscribers. Using various identifiers of a UE, a home public network can be identified. In some cases, the UE may roam to different geographic regions (e.g., different countries). The UE may attach to a roaming network, which may be referred to as a visiting network.

Some networks may support network slicing, which refers to the creation of virtual networks atop a physical infrastructure using software defined networking. As used herein, a network slice refers to a virtualized, independent logical network which can be multiplexed with other virtualized, independent logical networks on the same physical network infrastructure. Network slicing may allow network operators to provide different services or network domains to different users. For example, different network slices may be associated with applications or services associated with specific customer use cases, such as smart home, Internet of Everything (IoE), Internet of Things (IoT) factory, connected car, or other use cases.

Each network slice associated with a use case may be associated with a unique set of optimized resources and network topology that suit the needs of that use case, which may be referred to using a general traffic descriptor. These resources and network topology may provide a degree of connectivity, speed, capacity, throughput, latency, and reliability tailored to the use case associated with the use case.

Network slices may be identified to a UE via Single-Network Slice Selection Assistance Information (S-NSSAI) provided by the network to the UE. A UE may select particular network slices for particular communications functions. Some UEs may be capable of registering simultaneously with multiple network slices. If two S-NSSAIs are indicated as being part of the same Network Slice Simultaneous Registration Group (NSSRG), and the UE supports NSSRG, the UE may access two network slices concurrently.

While connected to a home PLMN (HPLMN) or to a visiting PLMN (VPLMN), a UE may connect to a non-third generation partnership project (3GPP) network using an interworking function (IWF) such as a non-3GPP interworking function (N3IWF). A network may provide non-3GPP access network (N3AN) node configuration information to a UE, which the UE may use to select an N3IWF. The N3AN configuration information may include N3IWF or Evolved Packet Data Gateway (ePDG) identifiers, which may include an IP address or a fully qualified domain name (FQDN). Upon selecting an N3IWF, the UE may register with the N3IWF and connect with the corresponding N3AN.

Currently available networks do not provide any mechanism by which a UE may take into account the network slices offered by different N3IWFs when selecting an N3IWF to which the UE will connect. To address this issue, this disclosure provides techniques by which a serving base station associated with a PLMN may indicate to the UE which network slices are supported by available N3IWFs. For example, the UE may receive N3AN node selection information that may indicate a set of N3IWFs and a set of network slices supported by each N3IWF. The UE may select an N3IWF based on one or more network slices supported by that N3IWF. The UE may then register with the N3IWF and connect to the N3AN based on an IP address associated with the N3IWF.

In some examples, the network slices may be indicated via NSSRGs associated with each N3IWF. In some examples, the N3AN selection information may indicate the IP addresses associated with the N3IWF. The UE may transmit a registration message to the N3IWF based on the IP address associated with the N3IWF. In some examples, the N3AN selection information may indicate an FQDN associated with the N3IWF.

In some examples, the N3AN node selection information may indicate to the UE to add a slicing prefix and may indicate prefix mapping information for mapping NSSRGs to a prefix. The UE may select a slicing prefix based on the selected networks slices and the mapping information and may transmit the slicing prefix with a name resolution request message to the network. In response, the network may transmit a message indicating the IP address associated with the selected N3IWF (e.g., based on the slicing prefix and/or the FQDN).

In some examples, if a UE is not configured to support NSSRGs, the serving base station in the network may indicate network slices that may be used concurrently and may also indicate one or more N3IWFs that support the indicated network slices. If a new network slice is not supported by the N3IWF, the PLMN may update the N3AN node configuration information to the UE such that the indicated N3IWF supports the indicated network slices.

In some examples, if the UE is operating in a roaming network (e.g., a VPLMN), the UE may have received slicing prefix information associated with the particular roaming network from UE's HPLMN. The UE may use the slicing prefix information associated with the particular roaming network when selecting an N3IWF in the roaming network.

Aspects of the disclosure are initially described in the context of wireless communications systems. Aspects of the disclosure are further illustrated by and described with reference to process flows, apparatus diagrams, system diagrams, and flowcharts that relate to IWF selection accounting for supported network slices.

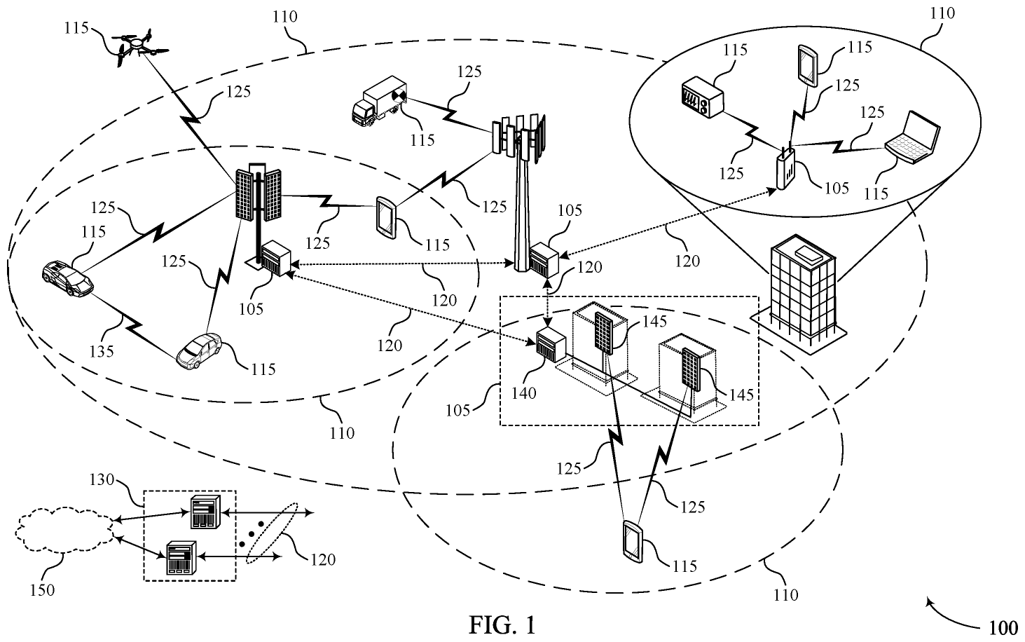

FIG. 1 illustrates an example of a wireless communications system 100 that supports IWF selection accounting for supported network slices in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an IoT device, an IoE device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

Thus, as described herein, a base station 105 may include one or more components that are located at a single physical location or one or more components located at various physical locations. In examples in which the base station 105 includes components that are located at various physical locations, the various components may each perform various functions such that, collectively, the various components achieve functionality that is similar to a base station 105 that is located at a single physical location. As such, a base station 105 described herein may equivalently refer to a standalone base station 105 (also known as a monolithic base station) or a base station 105 including components that are located at various physical locations or virtualized locations (also known as a disaggregated base station). In some implementations, such a base station 105 including components that are located at various physical locations may be referred to as or may be associated with a disaggregated radio access network (RAN) architecture, such as an Open RAN (O-RAN) or Virtualized RAN (VRAN) architecture. In some implementations, such components of a base station 105 may include or refer to one or more of a central unit (or centralized unit CU), a distributed unit (DU), or a radio unit (RU).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may be registered with and connected to a network (e.g., a PLMN associated with a core network 130). The network may be associated with a geographic region (e.g., a country) covered by a mobile operator to provide various wireless communication services (e.g., voice and data services) to mobile subscribers. In some cases, the UE 115 may roam to different geographic regions (e.g., different countries). The UE 115 may attach to a roaming network (e.g., associated with a VPLMN). Some networks may support network slicing. Network slices may be identified to a UE 115 via S-NSSAI provided by the network (e.g., via a serving base station 105) to the UE. A UE 115 may select particular network slices for particular communications functions. Some UEs 115 may be capable of simultaneous registration of multiple network slices. If two S-NSSAIs are indicated as being part of the same NSSRG, and the UE 115 supports NSSRG, the UE 115 may access two network slices concurrently. NSSRGs may be configured by an operator. A UE 115 that supports NSSRG and has received NSSRG information may be mandated by the network to include S-NSSAIs in the requested Network Slice Selection Assistance Information (NSSAI) that have at least one NSSRG in common (e.g., can be used at the same time).

While connected to a HPLMN or to a visiting VPLMN, a UE 115 may connect to a non-3GPP RAN using an N3IWF. A serving base station 105 may provide N3AN node configuration information to a UE 115, which a UE 115 may use to select an N3IWF. The N3AN configuration information may include N3AN node selection information, which may include one entry per PLMN and one entry for any PLMN (e.g., for VPLMNs). The N3AN node selection information may also include a PLMN identifier (ID), an FQDN format (e.g., operator ID or tracking areas format). N3AN node selection information may also include a preference for an N3IWF or an evolved packet data gateway (ePDG) as well as priority information. The N3AN configuration information may also include a home N3IWF identifier configuration, which may include one or multiple home N3IWF IDs, each including an IP address or an FQDN which identifies an N3IWF. The N3AN configuration information may also include a home ePDG identifier configuration, which may include one or more ePDG IDs, each including an IP address or an FQDN which identifies an ePDG.

A UE 115 may select an N3IWF based on the network provided N3AN configuration information. The UE 115 may register with the N3IWF and connect with the corresponding N3AN.

To enable selection of an N3IWF based on the supported network slices, the serving base station 105 associated with a PLMN may indicate to the UE 115 which network slices are supported by available N3IWFs. N3AN node selection information may indicate, to the UE 115, a set of N3IWFs and a set of network slices supported by each N3IWF. The UE 115 may select an N3IWFs based on one or more selected network slices. The UE 115 may register with the N3IWF and connect to the N3AN based on an IP address associated with the N3IWF. In some examples, the network slices may be indicated via NSSRGs associated with each N3IWF. In some examples, the N3AN selection information may indicate the IP addresses associated with the N3IWF. The UE 115 may transmit a registration message to the N3IWF based on the IP address associated with the N3IWF. In some examples, the N3AN selection information may indicate an FQDN associated with the N3IWF.

In some examples, the N3AN node selection information may indicate to the UE to add a slicing prefix and may indicate prefix mapping information for mapping NSSRGs to a prefix. The UE 115 may select a slicing prefix based on the selected networks slices and the mapping information and may transmit the slicing prefix with a name resolution request message to the network. In response, the network may transmit a message indicating the IP address associated with the selected N3IWF (e.g., based on the slicing prefix and/or the FQDN).

In some examples, if a UE 115 is not configured to support NSSRGs, the serving base station 105 in the network may indicate network slices that may be used concurrently and may also indicate one or more N3IWFs that support the indicated network slices. If a new network slice is not supported by the N3IWF, the PLMN may update the N3AN node configuration information to the UE 115 such that the indicated N3IWF supports the indicated network slices.

In some examples, if the UE 115 is operating in a roaming network (e.g., a VPLMN), the UE 115 may have received slicing prefix information associated with the particular roaming network from UE's HPLMN. The UE 115 may use the slicing prefix information associated with the particular roaming network when selecting an N3IWF in the roaming network.

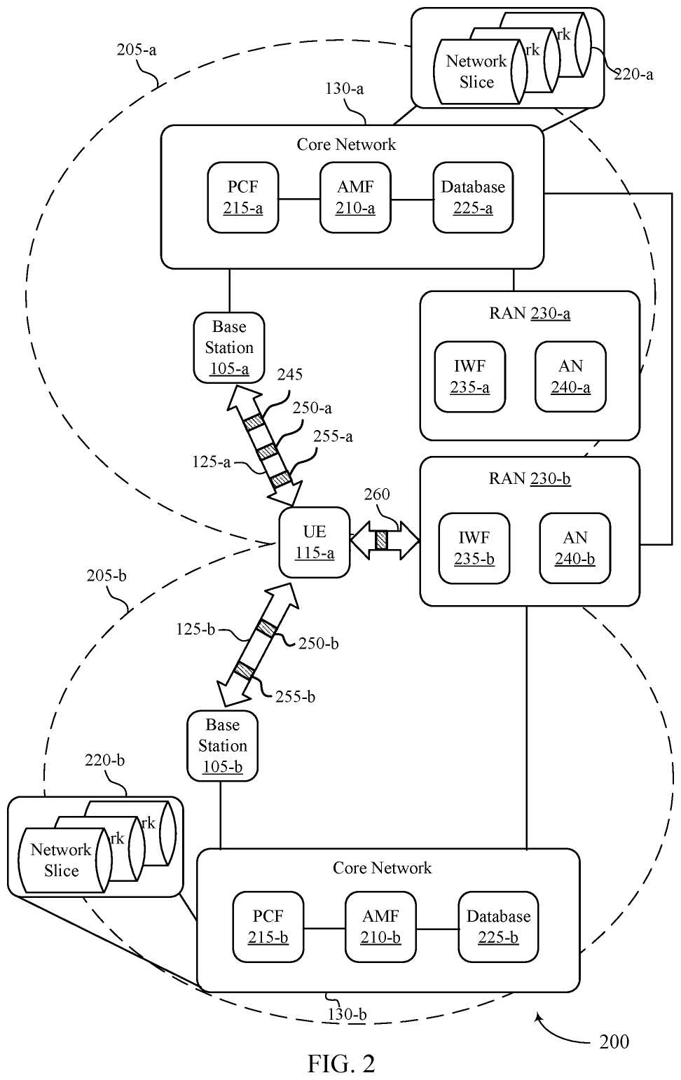

FIG. 2 illustrates an example of a wireless communications system 200 that supports IWF selection accounting for supported network slices in accordance with aspects of the present disclosure. The wireless communications system 200 may include a UE 115-a, which may be an example of a UE 115 as described herein. The wireless communications system 200 may include a base station 105-a and a base station 105-b, which may be examples of a base station 105 as described herein.

The UE 115-a may communicate with a first base station 105-a using a first communication link 125-a, which may be, for example, an NR or LTE link between the UE 115-a and the first base station 105-a, such as a Uu link. The UE 115-a may communicate with a second base station 105-b using a communication link 125-b, which may be an example of an NR or LTE link between the UE 115-a and the second base station 105-b, such as a Uu link.

The UE 115-a may be registered with a PLMN associated with the core network 130-a, which may be associated with a geographic region 205-a. The core network 130-a may be associated with a HPLMN. The core network 130-a may include an AMF 210-a, a policy control function (PCF) 215-a, and a database 225-a. The core network 130-a may support network slices 220-a. Network slicing allows the PLMN associated with the core network 130-a to provide for specific customer use cases, such as a smart home, IoE, IoT factory, connected car, etc. Each use case (e.g., slice) generally receives a unique set of optimized resources and network topology that suit the needs of the application (which may also be referred to as an general traffic descriptor), such as connectivity, speed, capacity, throughput, latency, and reliability. The core network 130-a may be connected to the internet and may communicate with RAN 230-a and RAN 230-b, which may be N3ANs. RAN 230-a may include an IWF 235-a and RAN 230-b may include an IWF 235-b. IWF 235-a and IWF 235-b may be N3IWFs. RAN 230-a may include an access node 240-a and RAN 230-b may include an access node 240-b.

In some examples, the UE 115-a may travel into a geographic region 205-b associated with a VPLMN that is associated with a core network 130-b. The core network 130-b may include an AMF 210-b, a PCF 215-b, and a database 225-b. The core network 130-b may support network slices 220-b. The core network may be connected to the internet and may communicate with RAN 230-a and RAN 230-b.

In some examples, the first base station 105-a may indicate, via the communications link 125-a, allowed S-NSSAIs associated with the network slices 220-a supported by the core network 130-a. In some examples, if the UE 115-a is within the home region 205-a, the first base station 105-a may be the serving base station associated with the core network 130-a, and may indicate access node configuration information to the UE 115-a via a control message 245. In some examples, the PCF 215-a may configure the first base station 105-a to transmit the control message 245. In some examples, the access node configuration information may include a home N3IWF identifier configuration (e.g., per NSSRG). The home N3IWF identifier configuration may include one or more home N3IWF identifiers (e.g., associated with IWF 235-a and IWF 235-b), each including an IP address or an FQDN which identifies the N3IWF. The home N3IWF identifier configuration information may also include NSSRG specific N3IWF information, including one or more entries including: a set of NSSRGs supported by the N3IWFs and one or more home N3IWF identifiers (e.g., associated with IWF 235-a and IWF 235-b), each including an IP address or an FQDN which identifies the N3IWF.

In some examples, the access node configuration information in the control message 245 may also include N3AN selection information. In some examples, the control message 245 may be a NAS message. The N3AN selection information may include an entry form the HPLMN associated with the core network 130-a, including: a PLMN ID (e.g., the HPLMN ID), an FQDN format (e.g., operator ID or Tracking area format), a preference indicator (e.g., for N3IWF or ePDG), and priority information. In some examples, the N3AN selection information may include slicing prefix information, which may include an indication to add a slicing prefix and prefix mapping information. Prefix mapping information may include one or more entries, each entry including one or more NSSRGs and an associated prefix.

If the UE 115-a is configured with the home N3IWF identifier configuration information in the access node configuration information received in the control message 245, the UE 115-a may select an entry from the home N3IWF identifier configuration for which the supported NSSRGs include at least one of the NSSRGs supported by all S-NSSAIs that the UE 115-a intends to request in the Requested NSSAI (transmitted to the selected IWF). The UE 115-a may use one of the home N3IWF identifiers of the selected entry as the N3IWF with which to register. If the home N3IWF identifier configuration indicated the IP address associated with the N3IWF, the UE 115-a may transmit a registration message 260 to register with the IWF 235-b (e.g., the selected N3IWF) and connect with the access node 240-b. If the home N3IWF identifier configuration indicated the FQDN, the UE 115-a may transmit a name resolution request message 250-a indicating the selected IWF to the first base station 105-a. In response, the first base station 105-a may transmit a message 255-a indicating the IP address associated with the selected IWF (e.g., based on the FQDN). The UE 115-a may transmit a registration message 260 to register with the IWF 235-b (e.g., the selected N3IWF) and connect with the access node 240-b. In some examples, the messages 250-a and 255-a may be NAS messages.

In some examples, if the UE 115-a is configured with the home N3IWF identifier configuration information in the access node configuration information received in the control message 245, the N3AN node selection information may include an indication to add slicing prefix and prefix mapping information. The UE 115-a may select a prefix mapping information that contains at least one NSSRG supported by all the NSSAIs that the UE 115-a will request in the requested NSSAI (transmitted to the selected IWF). The UE 115-a may transmit a name resolution request message 250-a to the first base station 105-a, the name resolution request message 250-a including the prefix contained in the mapping information that is associated with the selected N3IWF FQDN. The name resolution request message 250-a format may be based on the N3AN node selection information. In response, the first base station 105-a may transmit a message 255-a indicating the IP address associated with the selected IWF (e.g., based on the FQDN and the slicing prefix). The UE 115-a may transmit a registration message 260 to register with the IWF 235-b (e.g., the selected N3IWF) and connect with the access node 240-b. In some examples, the messages 250-a and 255-a may be NAS messages.

In some examples, if the UE 115-a selects an N3IWF using an FQDN with the slicing prefix added based on the prefix mapping information, but a domain name service (e.g., in the database 225-a) of the core network 130-a does not return an IP address, then the UE 115-a may send a second name resolution request message 250-a without adding a slicing prefix to the FQDN. In some examples, if the UE 115-a selects an N3IWF using an FQDN with the slicing prefix added based on the prefix mapping information, but the AMF 210-a detects that the N3IWF does not support the slices requested by the UE 115-a in the Requested NSSAI, then the AMF 210-a may update the slicing prefix information before rejecting the UE's registration request. The first base station 105-a may transmit an updated N3AN node configuration in a control message 245, and the UE 115-a may perform N3IWF selection again based on the updated N3AN node configuration.

In some examples, the UE 115-a may intend to register with one or more new network slices. In some examples, the UE 115-a may determine (based on the provided NSSRGs in the access node configuration information), whether the S-NSSAIs associated with the new network slice(s) share at least one NSSRG with the S-NSSAI in the allowed NSSAI that the UE 115-a received from the first base station 105-a (e.g., with the currently registered N3IWF). If the S-NSSAIs associated with the new network slice(s) do share at least one NSSRG with the S-NSSAI in the allowed NSSAI that the UE 115-a received from the first base station 105-a, the UE 115-a may select a different N3IWF that supports the new S-NSSAIs.

In some examples, the AMF 210-a may configure the first base station 105-a to provide the UE 115-a with slicing prefix information for the HPLMN associated with the core network 130-a when the AMF 210-a updates the configured NSSAI for the UE (e.g., as part of a mobility procedure).

In some examples, the UE 115-a may not support NSSRGs. Accordingly, the PLMN associated with the core network 130-a may provide to the UE 115-a, via the first base station 105-a, updated access network discovery and selection policy (ANDSP) information (e.g., via a control message 245) when the allowed NSSAI changes and the S-NSSAIs in the allowed NSSAI involve a different N3IWF (e.g., when the same N3IWFs no longer support the same network slices).

In some examples, if during an N3IWF registration procedure, an allowed NSSAI changes, the AMF 210-a may provide the allowed NSSAI to the PCF 215-a. If the selected N3IWF does not support a selected NSSAI because of the allowed NSSAI change, the PCF 215-a may update the N3AN node configuration, and the first base station 105-a may transmit the updated N3AN node configuration to the UE 115-a. The PCF 215-a may update the home N3IWF identifier configuration such that only N3IWF entries that support S-NSSAIs in the allowed NSSAI are included. In some examples, if the AMF 210-a determines that a currently selected N3IWF does not support a S-NSSAI in the allowed NSSAI, then the AMF 210-a may release the UE 115-a and indicate to the UE 115-a, via the first base station 105-a, to re-register with an N3IWF that supports the S-NSSAI. Accordingly, the UE 115-a may use N3IWF (e.g., IWF 235-a or IWF 235-b) that supports the S-NSSAIs in the indicated allowed NSSAIs.

In some examples, the UE 115-a may travel to the geographic region 205-b associated with the core network 130-b associated with a VPLMN (e.g., a roaming network). The UE 115-a may receive, from the home network (e.g., from the first base station 105-a in the control message 245) N3AN node selection information for different VPLMNs or for “any PLMN”. The N3AN node selection information for different VPLMNs or for “any PLMN” may be extended with additional information about the use of an additional slicing prefix for the different VPLMNs or for “any PLMN”.

The N3AN node selection information may include an entry for each VPLMN or for “any PLMN” that includes: a PLMN ID (of the VPLMNs or all zeros for “any PLMN”; an FQDN format (e.g., operator ID or tracking area format); preference (e.g., N3IWF or ePDG), priority, and slicing prefix information. The slicing prefix information may include an indication to add a slicing prefix and prefix mapping information including one or multiple entries, each including multiple NSSRGs and a prefix.

If the UE 115-a received N3AN selection information for a VPLMN that the UE 115-a intends to register with (e.g., if the UE 115-a intends to register with the core network 130-b), and the N3AN selection information indicates to add a slicing prefix, the UE 115-a may select a prefix mapping information entry that contains at least one NSSRG supported by all the S-NSSAIs that the UE 115-a intends to subsequently request in the Requested NSSAI. The UE 115-a may map the S-NSSAIs to the HPLMN NSSAIs. The UE 115-a may transmit a name resolution request message 250-b to the second base station 105-b, the name resolution request message 250-b including the prefix contained in the mapping information that is associated with the selected N3IWF FQDN. The name resolution request message 250-b format may be based on the N3AN node selection information. In response, the second base station 105-b may transmit a message 255-b indicating the IP address associated with the selected IWF (e.g., based on the FQDN and the slicing prefix). The UE 115-a may transmit a registration message 260 to register with the IWF 235-b (e.g., the selected N3IWF) and connect with the access node 240-b. In some examples, the messages 250-b and 255-b may be NAS messages.

If the UE 115-a determines that the VPLMN associated with the core network 130-b does not mandate the selection of an N3IWF, and the UE 115-a does not receive N3AN node selection information for the VPLMN associated with the core network 130-b, the UE 115-a may select an N3IWF in the HPLMN.

In some examples, the UE 115-a may intend to register with one or more new network slices while in the geographic region 205-b. In some examples, the UE 115-a may determine (based on the provided NSSRGs in the access node configuration information), whether the S-NSSAIs associated with the new network slice(s) share at least one NSSRG with the S-NSSAI in the allowed NSSAI that the UE 115-a received from the first base station 105-a (e.g., with the currently registered N3IWF). If the S-NSSAIs associated with the new network slice(s) do share at least one NSSRG with the S-NSSAI in the allowed NSSAI that the UE 115-a received from the first base station 105-a, the UE 115-a may select a different N3IWF that supports the new S-NSSAIs.

In some examples, the AMF 210-b may configure the second base station 105-b to provide the UE 115-a with slicing prefix information for the VPLMN associated with the core network 130-b when the AMF 210-a updates the configured NSSAI for the UE 115-a (e.g., as part of a mobility procedure).

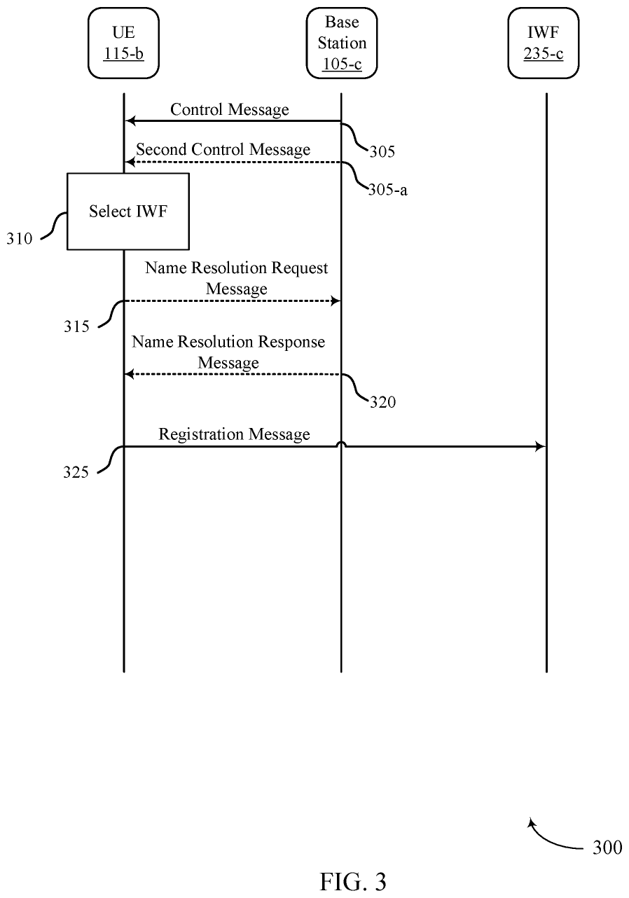

FIG. 3 illustrates an example of a process flow 300 that supports IWF selection accounting for supported network slices in accordance with aspects of the present disclosure. The process flow 300 may include a UE 115-b, which may be an example of a UE 115 as described herein. The process flow 300 may include a base station 105-c, which may be an example of a base station 105 as described herein. The process flow 300 may include an IWF 235-c, which may be an example of an IWF 235 as described herein. In the following description of the process flow 300, the operations between the UE 115-b, the base station 105-c, and the IWF 235-c may be transmitted in a different order than the example order shown, or the operations performed by the UE 115-b, the base station 105-c, and the IWF 235-c may be performed in different orders or at different times. Some operations may also be omitted from the process flow 300, and other operations may be added to the process flow 300.

At 305, the UE 115-b may receive, from the base station 105-c, a control message including an access network node configuration, the access network node configuration indicating a set of IWFs and a set of network slices associated with the set of IWFs. In some examples, the set of network slices may be used concurrently by the UE 115-b, and the set of IWFs are associated with the set of network slices that may be used concurrently.

At 310, the UE 115-b may select IWF from the set of IWFs based on a target network slice being indicated in the access network node configuration as associated with the selected IWF. For example, a target network slice may be a network slice with which the UE 115-b intends to register in order to support a specific customer use case (e.g., smart home, IoE, IoT factory, connected car, etc.). In some examples, the UE 115-b may select the IWF based on the selected network IWF being associated with an NSSRG including the target network slice, where the access network node configuration indicates a set of NSSRGs associated with each IWF of the set of IWFs.

In some examples, the access network node configuration indicates a respective IP address associated with each IWF of the set of IWFs, and at 325, the UE 115-b may transmit the registration message to the selected IWF based on the IP address associated with the IWF.

In some examples, the access network node configuration does not indicate a respective IP address associated with each IWF of the set of IWFs.

Accordingly, in some examples, at 315 the UE 115-b may transmit, to the base station 105-c, a name resolution request message indicating the selected IWF. In response, at 320, the base station 105-c may transmit, to the UE 115-b, an indication of an IP address associated with the selected IWF. At 325, the UE 115-b may transmit the registration message to the selected IWF based on the IP address associated with the IWF.

In some examples, the UE 115-b may receive, with the access network node configuration, an indication to add a slicing prefix to the name resolution request message. At 320, the UE 115-b may transmit, with the name resolution request message, a selected slicing prefix associated with an NSSRG associated with the target network slice. In some examples, the UE 115-b may receive, with the access network node configuration, an indication of prefix mapping information indicating a set of NSSRGs and an associated set of slicing prefixes. The UE 115-b may select the selected slicing prefix based on the NSSRG associated with the selected slicing prefix being associated with the target network slice. In some examples, receiving the indication to add the slicing prefix to the name resolution request message is based on receiving the indication of prefix mapping information

In some examples, the UE 115-b may select a second target network slice for concurrent use with the target network slice. The UE 115-b may select, based on determining that the IWF is not associated with the second target network slice, a second IWF of the set of IWFs, the second IWF associated with the target network slice and the second target network slice. The UE 115-b may transmit a second registration message to the IWF 235-c.

In some examples, the UE 115-b may receive a second control message 305-a indicating a second set of network slices. The UE 115-b may select target network slice from the second set of network slices based on a target communication function (e.g., IoT, IoE, Wi-Fi calling, etc.). In some examples, the UE 115-b may receive the second control message in a mobility management message. In some examples, the UE 115-b may receive, with the second control message, an indication of prefix mapping information indicating a set of NSSRGs and an associated set of slicing prefixes. In some examples, the UE may transmit, at 320, with a name resolution request, a selected slicing prefix indicating an NSSRG associated with the target network slice based on the indication of the prefix mapping information.

In some examples, the UE 115-b may receive, from a home network, an indication of access network node selection information for a roaming network, the access network node selection information indicating prefix mapping information indicating a set of NSSRGs and an associated set of slicing prefixes for the roaming network. The UE 115-b may receive a second control message from a roaming network, and the UE 115-b may transmit to a base station associated with the visiting network, with a name resolution request message, a selected slicing prefix indicating an NSSRG associated with the target network slice based on the indication of the prefix mapping information.

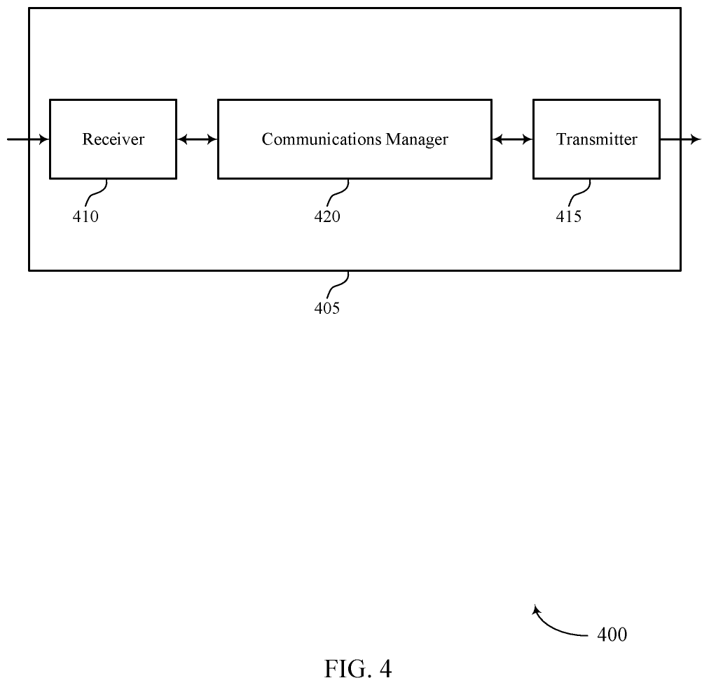

FIG. 4 shows a block diagram 400 of a device 405 that supports IWF selection accounting for supported network slices in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to IWF selection accounting for supported network slices). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to IWF selection accounting for supported network slices). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of IWF selection accounting for supported network slices as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communications at a UE in accordance with examples as disclosed herein. For example, the communications manager 420 may be configured as or otherwise support a means for receiving a control message including an access network node configuration, the access network node configuration indicating a set of IWFs and a set of network slices associated with the set of IWFs. The communications manager 420 may be configured as or otherwise support a means for selecting an IWF from the set of IWFs based on a target network slice being indicated in the access network node configuration as associated with the selected IWF. The communications manager 420 may be configured as or otherwise support a means for transmitting a registration message to the selected IWF.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for more efficient utilization of communication resources by accounting for target network slices when selecting IWFs.

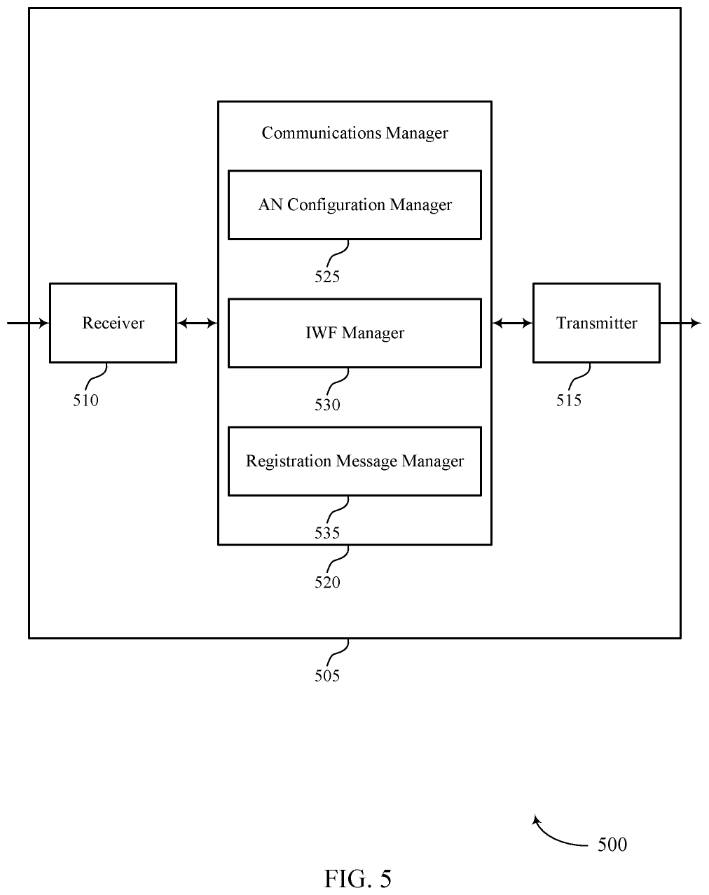

FIG. 5 shows a block diagram 500 of a device 505 that supports IWF selection accounting for supported network slices in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to IWF selection accounting for supported network slices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to IWF selection accounting for supported network slices). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of IWF selection accounting for supported network slices as described herein. For example, the communications manager 520 may include an access node (AN) configuration manager 525, an IWF manager 530, a registration message manager 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. The AN configuration manager 525 may be configured as or otherwise support a means for receiving a control message including an access network node configuration, the access network node configuration indicating a set of IWFs and a set of network slices associated with the set of IWFs. The IWF manager 530 may be configured as or otherwise support a means for selecting an IWF from the set of IWFs based on a target network slice being indicated in the access network node configuration as associated with the selected IWF. The registration message manager 535 may be configured as or otherwise support a means for transmitting a registration message to the selected IWF.

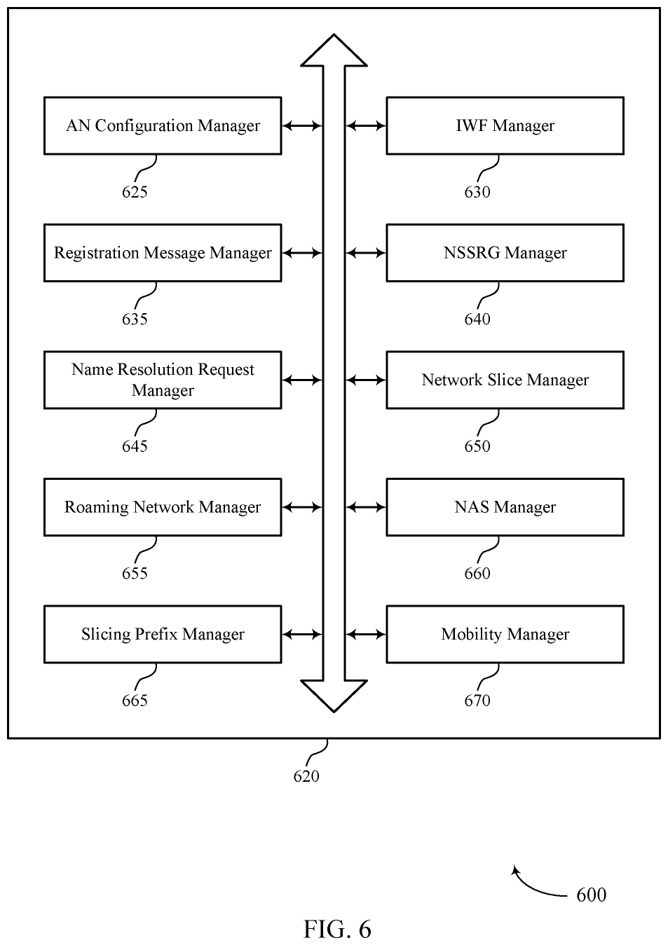

FIG. 6 shows a block diagram 600 of a communications manager 620 that supports IWF selection accounting for supported network slices in accordance with aspects of the present disclosure. The communications manager 620 may be an example of aspects of a communications manager 420, a communications manager 520, or both, as described herein. The communications manager 620, or various components thereof, may be an example of means for performing various aspects of IWF selection accounting for supported network slices as described herein. For example, the communications manager 620 may include an AN configuration manager 625, an IWF manager 630, a registration message manager 635, an NSSRG manager 640, a name resolution request manager 645, a network slice manager 650, a roaming network manager 655, a NAS manager 660, a slicing prefix manager 665, a mobility manager 670, or any combination thereof. Each of these components may communicate, directly or indirectly, with one another (e.g., via one or more buses).

The communications manager 620 may support wireless communications at a UE in accordance with examples as disclosed herein. The AN configuration manager 625 may be configured as or otherwise support a means for receiving a control message including an access network node configuration, the access network node configuration indicating a set of IWFs and a set of network slices associated with the set of IWFs. The IWF manager 630 may be configured as or otherwise support a means for selecting an IWF from the set of IWFs based on a target network slice being indicated in the access network node configuration as associated with the selected IWF. The registration message manager 635 may be configured as or otherwise support a means for transmitting a registration message to the selected IWF.

In some examples, the NSSRG manager 640 may be configured as or otherwise support a means for selecting the IWF based on the selected network IWF being associated with an NSSRG including the target network slice, where the access network node configuration indicates a set of NSSRGs associated with each IWF of the set of IWFs.

In some examples, the network slice manager 650 may be configured as or otherwise support a means for selecting a second target network slice for concurrent use with the target network slice. In some examples, the IWF manager 630 may be configured as or otherwise support a means for selecting, based on determining that the IWF is not associated with the second target network slice, a second IWF of the set of IWFs, the second IWF associated with the target network slice and the second target network slice. In some examples, the registration message manager 635 may be configured as or otherwise support a means for transmitting a second registration message indicating the selected second IWF.

In some examples, the name resolution request manager 645 may be configured as or otherwise support a means for transmitting a name resolution request message indicating the selected IWF. In some examples, the IWF manager 630 may be configured as or otherwise support a means for receiving, in response to the name resolution request message, an indication of an IP address associated with the selected IWF, where the registration message is based on the IP address associated with the selected IWF.

In some examples, the slicing prefix manager 665 may be configured as or otherwise support a means for receiving, with the access network node configuration, an indication to add a slicing prefix to the name resolution request message. In some examples, the name resolution request manager 645 may be configured as or otherwise support a means for transmitting, with the name resolution request message, a selected slicing prefix associated with an NSSRG associated with the target network slice.

In some examples, the slicing prefix manager 665 may be configured as or otherwise support a means for receiving, with the access network node configuration, an indication of prefix mapping information indicating a set of NSSRGs and an associated set of slicing prefixes. In some examples, the NSSRG manager 640 may be configured as or otherwise support a means for selecting the selected slicing prefix based on the NSSRG associated with the selected slicing prefix being associated with the target network slice.

In some examples, receiving the indication to add the slicing prefix to the name resolution request message includes receiving the indication of prefix mapping information.

In some examples, the network slice manager 650 may be configured as or otherwise support a means for receiving a second control message indicating a second set of network slices. In some examples, the network slice manager 650 may be configured as or otherwise support a means for selecting the target network slice from the second set of network slices based on a target communication function.

In some examples, to support receiving the second control message, the mobility manager 670 may be configured as or otherwise support a means for receiving the second control message in a mobility management message.

In some examples, the network slice manager 650 may be configured as or otherwise support a means for receiving, with the second control message, an indication of prefix mapping information indicating a set of NSSRGs and an associated set of slicing prefixes. In some examples, the name resolution request manager 645 may be configured as or otherwise support a means for transmitting, with a name resolution request, a selected slicing prefix indicating an NSSRG associated with the target network slice based on the indication of the prefix mapping information.

In some examples, the set of network slices may be used concurrently by the UE, and the set of IWFs are associated with the set of network slices that may be used concurrently.

In some examples, the roaming network manager 655 may be configured as or otherwise support a means for receiving, from a home network, an indication of access network node selection information for a roaming network, the access network node selection information indicating prefix mapping information indicating a set of NSSRGs and an associated set of slicing prefixes for the roaming network. In some examples, the roaming network manager 655 may be configured as or otherwise support a means for receiving, from a roaming network, a second control message. In some examples, the name resolution request manager 645 may be configured as or otherwise support a means for transmitting, with a name resolution request message, a selected slicing prefix indicating an NSSRG associated with the target network slice based on the indication of the prefix mapping information.

In some examples, the NAS manager 660 may be configured as or otherwise support a means for receiving the control message as a non-access stratum message.

In some examples, the registration message manager 635 may be configured as or otherwise support a means for transmitting the registration message to the selected IWF based on an IP address associated with the IWF, where the access network node configuration indicates a respective IP address associated with each IWF of the set of IWFs.

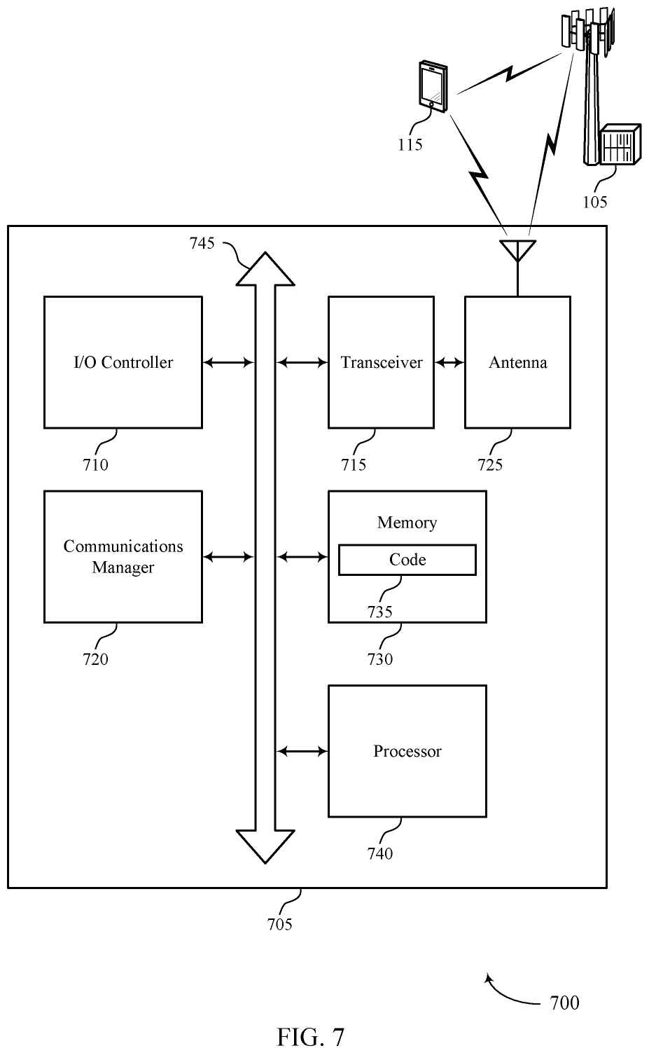

FIG. 7 shows a diagram of a system 700 including a device 705 that supports IWF selection accounting for supported network slices in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting IWF selection accounting for supported network slices). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving a control message including an access network node configuration, the access network node configuration indicating a set of IWFs and a set of network slices associated with the set of IWFs. The communications manager 720 may be configured as or otherwise support a means for selecting an IWF from the set of IWFs based on a target network slice being indicated in the access network node configuration as associated with the selected IWF. The communications manager 720 may be configured as or otherwise support a means for transmitting a registration message to the selected IWF.

By including or configuring the communications manager 720 in accordance with examples as described herein, the device 705 may support techniques for more efficient utilization of communication resources and improved coordination between devices by accounting for target network slices when selecting IWFs.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of IWF selection accounting for supported network slices as described herein, or the processor 740 and the memory 730 may be otherwise configured to perform or support such operations.

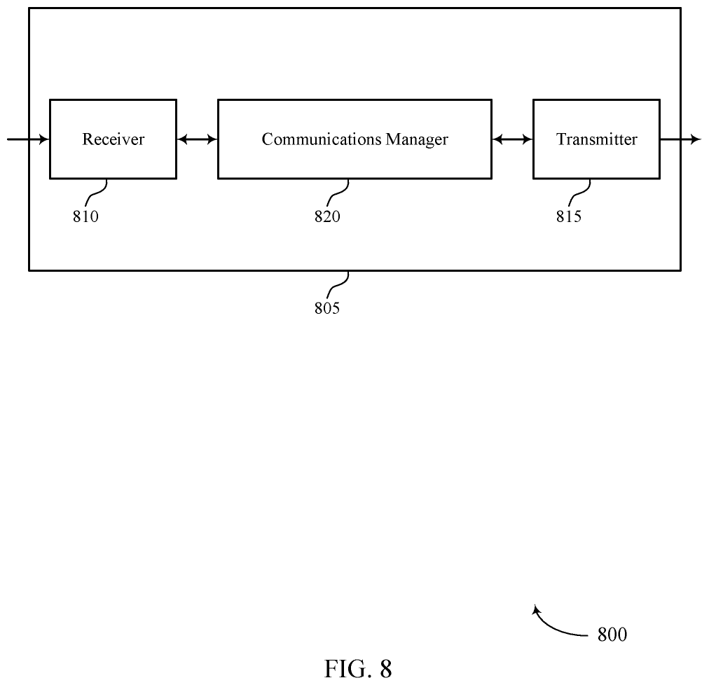

FIG. 8 shows a block diagram 800 of a device 805 that supports IWF selection accounting for supported network slices in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to IWF selection accounting for supported network slices). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to IWF selection accounting for supported network slices). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of IWF selection accounting for supported network slices as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a base station in accordance with examples as disclosed herein. For example, the communications manager 820 may be configured as or otherwise support a means for transmitting, to a UE, a control message including an access network node configuration, the access network node configuration indicating a set of IWFs and a set of network slices associated with the set of IWFs. The communications manager 820 may be configured as or otherwise support a means for receiving, from the UE, a name resolution request message indicating a selected IWF based on the access network node configuration.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for more efficient utilization of communication resources by enabling accounting for target network slices when selecting IWFs.

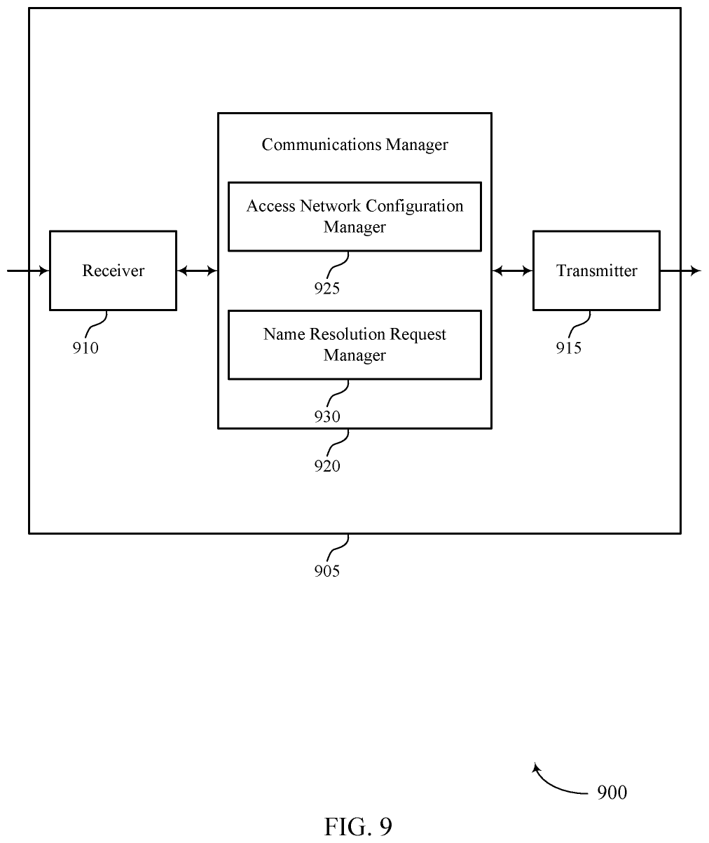

FIG. 9 shows a block diagram 900 of a device 905 that supports IWF selection accounting for supported network slices in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to IWF selection accounting for supported network slices). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to IWF selection accounting for supported network slices). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of IWF selection accounting for supported network slices as described herein. For example, the communications manager 920 may include an access network configuration manager 925 a name resolution request manager 930, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. The access network configuration manager 925 may be configured as or otherwise support a means for transmitting, to a UE, a control message including an access network node configuration, the access network node configuration indicating a set of IWFs and a set of network slices associated with the set of IWFs. The name resolution request manager 930 may be configured as or otherwise support a means for receiving, from the UE, a name resolution request message indicating a selected IWF based on the access network node configuration.

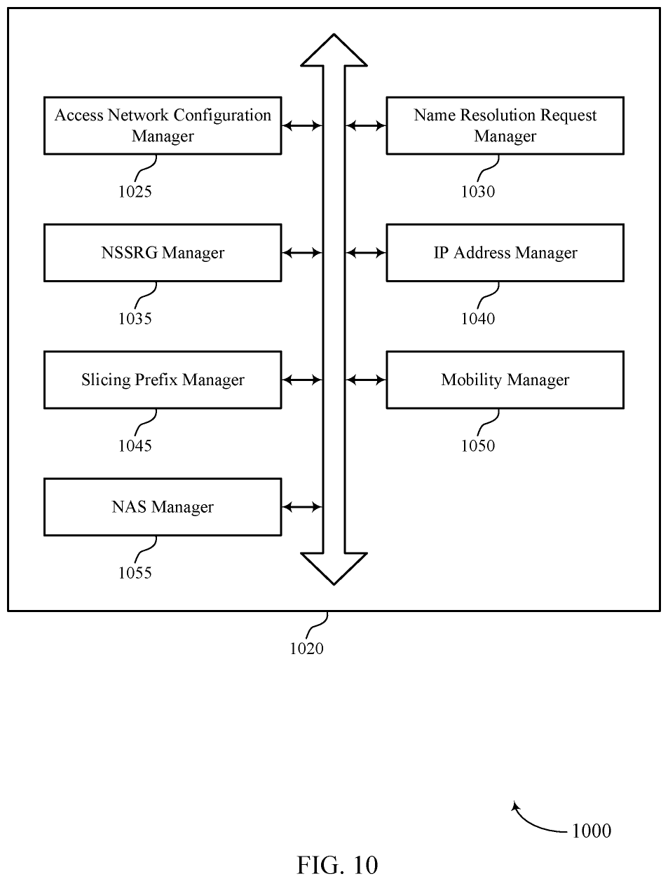

FIG. 10 shows a block diagram 1000 of a communications manager 1020 that supports IWF selection accounting for supported network slices in accordance with aspects of the present disclosure. The communications manager 1020 may be an example of aspects of a communications manager 820, a communications manager 920, or both, as described herein. The communications manager 1020, or various components thereof, may be an example of means for performing various aspects of IWF selection accounting for supported network slices as described herein. For example, the communications manager 1020 may include an access network configuration manager 1025, a name resolution request manager 1030, an NSSRG manager 1035, an IP address manager 1040, a slicing prefix manager 1045, a mobility manager 1050, a NAS manager 1055, or any combination thereof. Each of these components may communicate, directly or indirectly, with one another (e.g., via one or more buses).

The communications manager 1020 may support wireless communications at a base station in accordance with examples as disclosed herein. The access network configuration manager 1025 may be configured as or otherwise support a means for transmitting, to a UE, a control message including an access network node configuration, the access network node configuration indicating a set of IWFs and a set of network slices associated with the set of IWFs. The name resolution request manager 1030 may be configured as or otherwise support a means for receiving, from the UE, a name resolution request message indicating a selected IWF based on the access network node configuration.

In some examples, the NSSRG manager 1035 may be configured as or otherwise support a means for transmitting, with the access network node configuration, a set of NSSRGs associated with each IWF of the set of IWFs.

In some examples, the IP address manager 1040 may be configured as or otherwise support a means for transmitting, to the UE, in response to the name resolution request message, an indication of an IP address associated with the selected IWF.

In some examples, the slicing prefix manager 1045 may be configured as or otherwise support a means for transmitting, with the access network node configuration, an indication to add a slicing prefix to the name resolution request message. In some examples, the name resolution request manager 1030 may be configured as or otherwise support a means for receiving, with the name resolution request message, a selected slicing prefix indicating an NSSRG associated with a target network slice.

In some examples, the slicing prefix manager 1045 may be configured as or otherwise support a means for transmitting, with the access network node configuration, an indication of prefix mapping information indicating a set of NSSRGs and an associated set of slicing prefixes, where the selected slicing prefix is based on the NSSRG associated with the selected slicing prefix being associated with the target network slice.

In some examples, transmitting the indication to add the slicing prefix to the name resolution request message includes receiving the indication of prefix mapping information.

In some examples, the mobility manager 1050 may be configured as or otherwise support a means for transmitting, to the UE, an access and mobility message indicating a second set of network slices.

In some examples, the slicing prefix manager 1045 may be configured as or otherwise support a means for transmitting, with the access and mobility message, an indication of prefix mapping information indicating a set of NSSRGs and an associated set of slicing prefixes. In some examples, the name resolution request manager 1030 may be configured as or otherwise support a means for receiving, with the name resolution request message, a selected slicing prefix indicating an NSSRG associated with a target network slice based on the indication of the prefix mapping information.

In some examples, the set of network slices may be used concurrently by the UE, and the set of IWFs are associated with the set of network slices that may be used concurrently.

In some examples, the NAS manager 1055 may be configured as or otherwise support a means for transmitting the control message as a non-access stratum message.

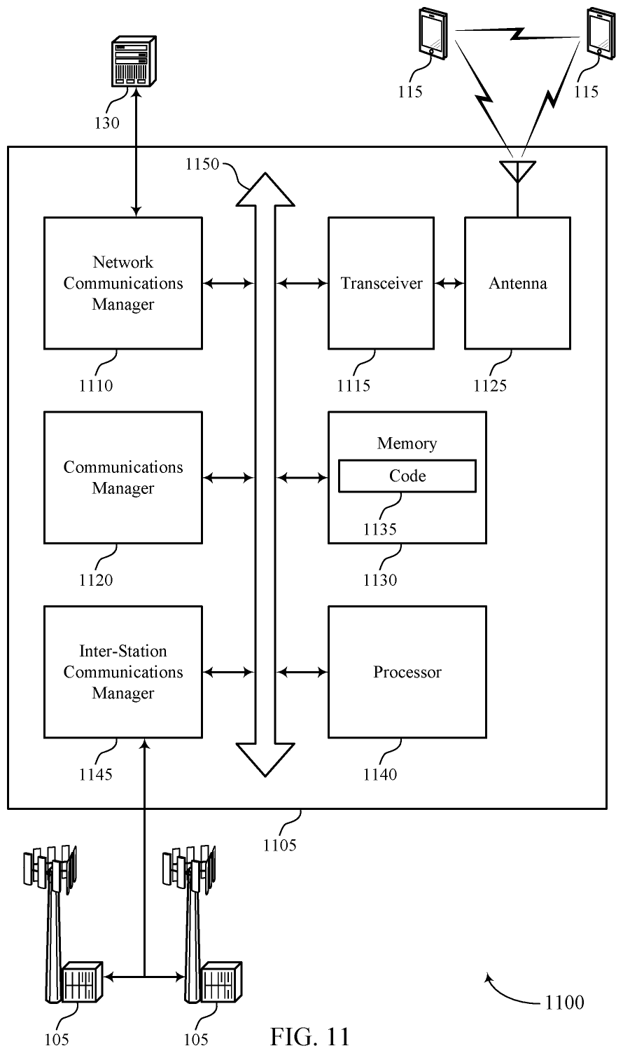

FIG. 11 shows a diagram of a system 1100 including a device 1105 that supports IWF selection accounting for supported network slices in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting IWF selection accounting for supported network slices). For example, the device 1105 or a component of the device 1105 may include a processor 1140 and memory 1130 coupled with or to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communications at a base station in accordance with examples as disclosed herein. For example, the communications manager 1120 may be configured as or otherwise support a means for transmitting, to a UE, a control message including an access network node configuration, the access network node configuration indicating a set of IWFs and a set of network slices associated with the set of IWFs. The communications manager 1120 may be configured as or otherwise support a means for receiving, from the UE, a name resolution request message indicating a selected IWF based on the access network node configuration.

By including or configuring the communications manager 1120 in accordance with examples as described herein, the device 1105 may support techniques for more efficient utilization of communication resources and improved coordination between devices by enabling accounting for target network slices when selecting IWFs.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of IWF selection accounting for supported network slices as described herein, or the processor 1140 and the memory 1130 may be otherwise configured to perform or support such operations.

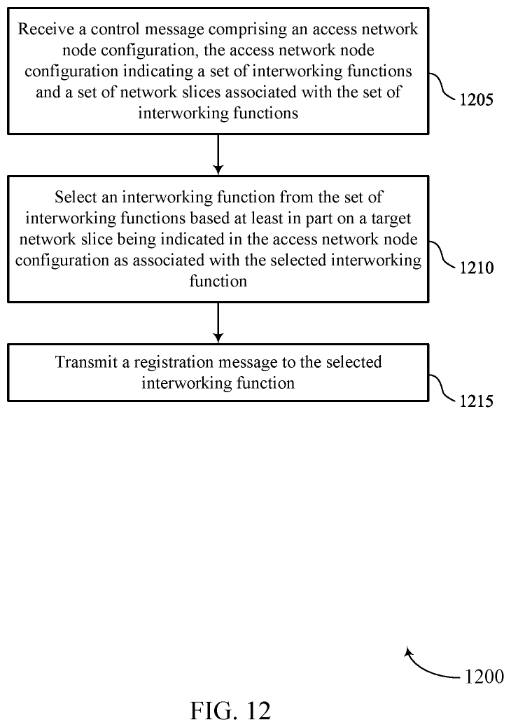

FIG. 12 shows a flowchart illustrating a method 1200 that supports IWF selection accounting for supported network slices in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a control message including an access network node configuration, the access network node configuration indicating a set of IWFs and a set of network slices associated with the set of IWFs. The operations of 1205 may be performed in accordance with examples as disclosed herein. In some examples, aspects of the operations of 1205 may be performed by an AN configuration manager 625 as described with reference to FIG. 6.

At 1210, the method may include selecting an IWF from the set of IWFs based on a target network slice being indicated in the access network node configuration as associated with the selected IWF. The operations of 1210 may be performed in accordance with examples as disclosed herein. In some examples, aspects of the operations of 1210 may be performed by an IWF manager 630 as described with reference to FIG. 6.

At 1215, the method may include transmitting a registration message to the selected IWF. The operations of 1215 may be performed in accordance with examples as disclosed herein. In some examples, aspects of the operations of 1215 may be performed by a registration message manager 635 as described with reference to FIG. 6.

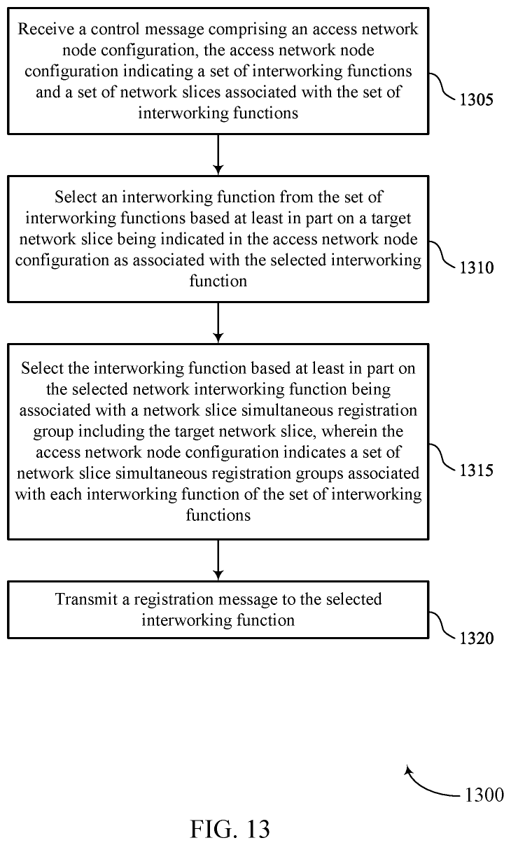

FIG. 13 shows a flowchart illustrating a method 1300 that supports IWF selection accounting for supported network slices in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a control message including an access network node configuration, the access network node configuration indicating a set of IWFs and a set of network slices associated with the set of IWFs. The operations of 1305 may be performed in accordance with examples as disclosed herein. In some examples, aspects of the operations of 1305 may be performed by an AN configuration manager 625 as described with reference to FIG. 6.

At 1310, the method may include selecting an IWF from the set of IWFs based on a target network slice being indicated in the access network node configuration as associated with the selected IWF. The operations of 1310 may be performed in accordance with examples as disclosed herein. In some examples, aspects of the operations of 1310 may be performed by an IWF manager 630 as described with reference to FIG. 6.

At 1315, the method may include selecting the IWF based on the selected network IWF being associated with an NSSRG including the target network slice, where the access network node configuration indicates a set of NSSRGs associated with each IWF of the set of IWFs. The operations of 1315 may be performed in accordance with examples as disclosed herein. In some examples, aspects of the operations of 1315 may be performed by an NSSRG manager 640 as described with reference to FIG. 6.

At 1320, the method may include transmitting a registration message to the selected IWF. The operations of 1320 may be performed in accordance with examples as disclosed herein. In some examples, aspects of the operations of 1320 may be performed by a registration message manager 635 as described with reference to FIG. 6.

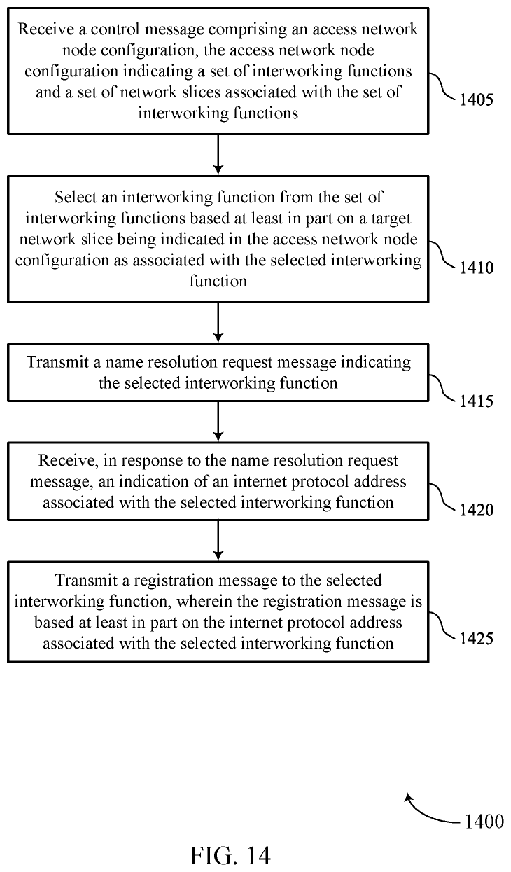

FIG. 14 shows a flowchart illustrating a method 1400 that supports IWF selection accounting for supported network slices in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving a control message including an access network node configuration, the access network node configuration indicating a set of IWFs and a set of network slices associated with the set of IWFs. The operations of 1405 may be performed in accordance with examples as disclosed herein. In some examples, aspects of the operations of 1405 may be performed by an AN configuration manager 625 as described with reference to FIG. 6.

At 1410, the method may include selecting an IWF from the set of IWFs based on a target network slice being indicated in the access network node configuration as associated with the selected IWF. The operations of 1410 may be performed in accordance with examples as disclosed herein. In some examples, aspects of the operations of 1410 may be performed by an IWF manager 630 as described with reference to FIG. 6.

At 1415, the method may include transmitting a name resolution request message indicating the selected IWF. The operations of 1415 may be performed in accordance with examples as disclosed herein. In some examples, aspects of the operations of 1415 may be performed by a name resolution request manager 645 as described with reference to FIG. 6.

At 1420, the method may include receiving, in response to the name resolution request message, an indication of an IP address associated with the selected IWF. The operations of 1420 may be performed in accordance with examples as disclosed herein. In some examples, aspects of the operations of 1420 may be performed by an IWF manager 630 as described with reference to FIG. 6.

At 1425, the method may include transmitting a registration message to the selected IWF, where the registration message is based on the IP address associated with the selected IWF. The operations of 1425 may be performed in accordance with examples as disclosed herein. In some examples, aspects of the operations of 1425 may be performed by a registration message manager 635 as described with reference to FIG. 6.

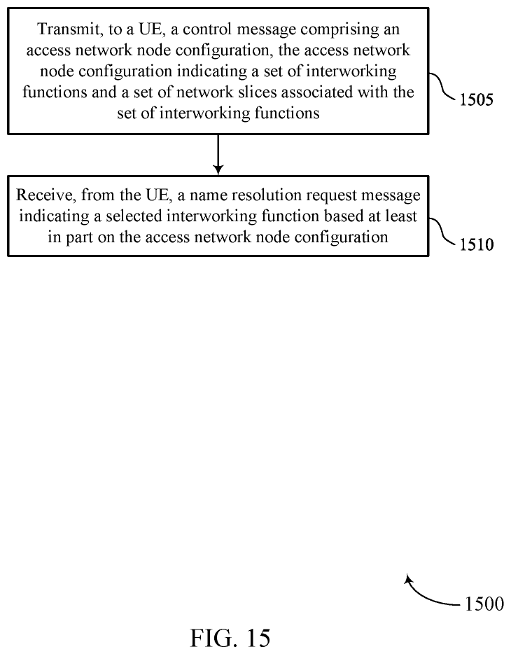

FIG. 15 shows a flowchart illustrating a method 1500 that supports IWF selection accounting for supported network slices in accordance with aspects of the present disclosure. The operations of the method 1500 may be implemented by a base station or its components as described herein. For example, the operations of the method 1500 may be performed by a base station 105 as described with reference to FIGS. 1 through 3 and 8 through 11. In some examples, a base station may execute a set of instructions to control the functional elements of the base station to perform the described functions. Additionally, or alternatively, the base station may perform aspects of the described functions using special-purpose hardware.

At 1505, the method may include transmitting, to a UE, a control message including an access network node configuration, the access network node configuration indicating a set of IWFs and a set of network slices associated with the set of IWFs. The operations of 1505 may be performed in accordance with examples as disclosed herein. In some examples, aspects of the operations of 1505 may be performed by an access network configuration manager 1025 as described with reference to FIG. 10.

At 1510, the method may include receiving, from the UE, a name resolution request message indicating a selected IWF based on the access network node configuration. The operations of 1510 may be performed in accordance with examples as disclosed herein. In some examples, aspects of the operations of 1510 may be performed by a name resolution request manager 1030 as described with reference to FIG. 10.

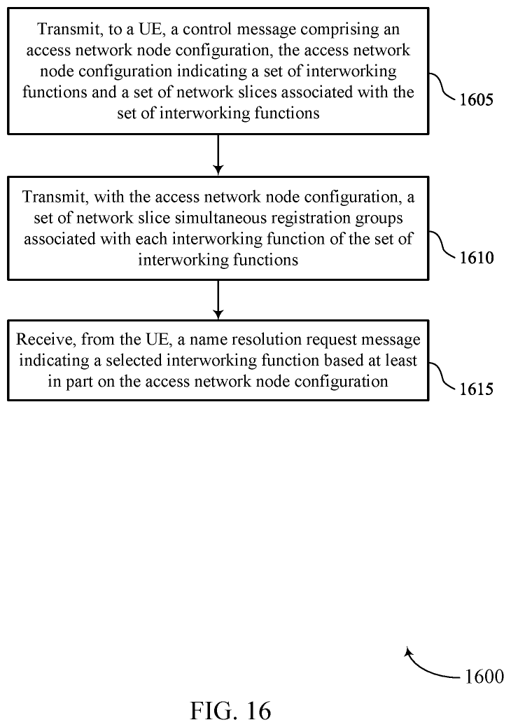

FIG. 16 shows a flowchart illustrating a method 1600 that supports IWF selection accounting for supported network slices in accordance with aspects of the present disclosure. The operations of the method 1600 may be implemented by a base station or its components as described herein. For example, the operations of the method 1600 may be performed by a base station 105 as described with reference to FIGS. 1 through 3 and 8 through 11. In some examples, a base station may execute a set of instructions to control the functional elements of the base station to perform the described functions. Additionally, or alternatively, the base station may perform aspects of the described functions using special-purpose hardware.

At 1605, the method may include transmitting, to a UE, a control message including an access network node configuration, the access network node configuration indicating a set of IWFs and a set of network slices associated with the set of IWFs. The operations of 1605 may be performed in accordance with examples as disclosed herein. In some examples, aspects of the operations of 1605 may be performed by an access network configuration manager 1025 as described with reference to FIG. 10.

At 1610, the method may include receiving, from the UE, a name resolution request message indicating a selected IWF based on the access network node configuration. The operations of 1610 may be performed in accordance with examples as disclosed herein. In some examples, aspects of the operations of 1610 may be performed by a name resolution request manager 1030 as described with reference to FIG. 10.

At 1615, the method may include transmitting, with the access network node configuration, a set of NSSRGs associated with each IWF of the set of IWFs. The operations of 1615 may be performed in accordance with examples as disclosed herein. In some examples, aspects of the operations of 1615 may be performed by an NSSRG manager 1035 as described with reference to FIG. 10.

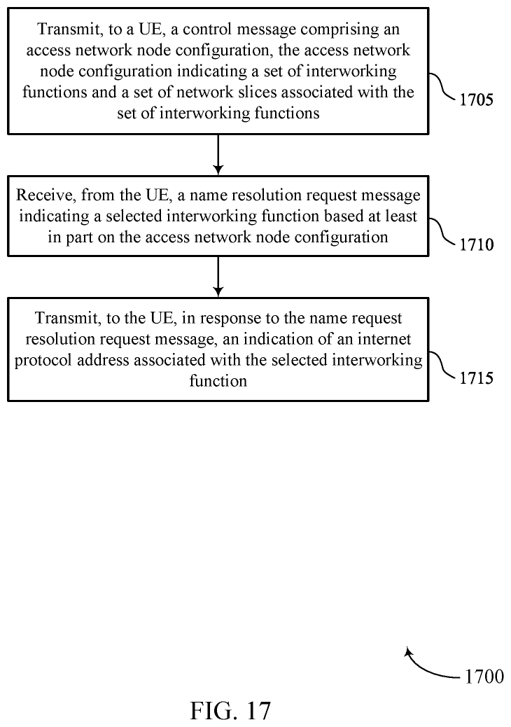

FIG. 17 shows a flowchart illustrating a method 1700 that supports IWF selection accounting for supported network slices in accordance with aspects of the present disclosure. The operations of the method 1700 may be implemented by a base station or its components as described herein. For example, the operations of the method 1700 may be performed by a base station 105 as described with reference to FIGS. 1 through 3 and 8 through 11. In some examples, a base station may execute a set of instructions to control the functional elements of the base station to perform the described functions. Additionally, or alternatively, the base station may perform aspects of the described functions using special-purpose hardware.

At 1705, the method may include transmitting, to a UE, a control message including an access network node configuration, the access network node configuration indicating a set of IWFs and a set of network slices associated with the set of IWFs. The operations of 1705 may be performed in accordance with examples as disclosed herein. In some examples, aspects of the operations of 1705 may be performed by an access network configuration manager 1025 as described with reference to FIG. 10.

At 1710, the method may include receiving, from the UE, a name resolution request message indicating a selected IWF based on the access network node configuration. The operations of 1710 may be performed in accordance with examples as disclosed herein. In some examples, aspects of the operations of 1710 may be performed by a name resolution request manager 1030 as described with reference to FIG. 10.

At 1715, the method may include transmitting, to the UE, in response to the name resolution request message, an indication of an IP address associated with the selected IWF. The operations of 1715 may be performed in accordance with examples as disclosed herein. In some examples, aspects of the operations of 1715 may be performed by an IP address manager 1040 as described with reference to FIG. 10.

The following provides an overview of aspects of the present disclosure:

Aspect 1: A method for wireless communications at a UE, comprising: receiving a control message comprising an access network node configuration, the access network node configuration indicating a set of IWFs and a set of network slices associated with the set of IWFs; selecting an IWF from the set of IWFs based at least in part on a target network slice being indicated in the access network node configuration as associated with the selected IWF; and transmitting a registration message to the selected IWF.

Aspect 2: The method of aspect 1, further comprising: selecting the IWF based at least in part on the selected IWF being associated with a network slice simultaneous registration group including the target network slice, wherein the access network node configuration indicates a set of network slice simultaneous registration groups associated with each IWF of the set of IWFs.

Aspect 3: The method of aspect 2, further comprising: selecting a second target network slice for concurrent use with the target network slice; selecting, based at least in part on determining that the IWF is not associated with the second target network slice, a second IWF of the set of IWFs, the second IWF associated with the target network slice and the second target network slice; and transmitting a second registration message indicating the selected second IWF.

Aspect 4: The method of any of aspects 1 through 3, further comprising: transmitting a name resolution request message indicating the selected IWF; and receiving, in response to the name resolution request message, an indication of an internet protocol address associated with the selected IWF, wherein the registration message is based at least in part on the internet protocol address associated with the selected IWF.

Aspect 5: The method of any of aspects 1 through 4, further comprising: receiving, with the access network node configuration, an indication to add a slicing prefix to a name resolution request message; and transmitting, with the name resolution request message, a selected slicing prefix associated with the target network slice.

Aspect 6: The method of aspect 5, further comprising: receiving, with the access network node configuration, an indication of prefix mapping information indicating a set of network slice simultaneous registration groups and an associated set of slicing prefixes; and selecting the selected slicing prefix based at least in part on the network slice simultaneous registration group associated with the selected slicing prefix being associated with the target network slice.

Aspect 7: The method of aspect 6, wherein receiving the indication to add the slicing prefix to the name resolution request message comprises receiving the indication of prefix mapping information.

Aspect 8: The method of any of aspects 1 through 7, further comprising: receiving a second control message indicating a second set of network slices; and selecting the target network slice from the second set of network slices based at least in part on a target communication function.

Aspect 9: The method of aspect 8, wherein receiving the second control message comprises: receiving the second control message in a mobility management message.

Aspect 10: The method of aspect 9, further comprising: receiving, with the second control message, an indication of prefix mapping information indicating a set of network slice simultaneous registration groups and an associated set of slicing prefixes; and transmitting, with a name resolution request, a selected slicing prefix indicating a network slice simultaneous registration group associated with the target network slice based at least in part on the indication of the prefix mapping information.

Aspect 11: The method of any of aspects 1 through 10, wherein the set of network slices may be used concurrently by the UE, and the set of IWFs are associated with the set of network slices that may be used concurrently.

Aspect 12: The method of any of aspects 1 through 11, further comprising: receiving, from a home network, an indication of access network node selection information for a roaming network, the access network node selection information indicating prefix mapping information indicating a set of network slice simultaneous registration groups and an associated set of slicing prefixes for the roaming network; receiving, from the roaming network, a second control message; and transmitting, with a name resolution request message, a selected slicing prefix indicating a network slice simultaneous registration group associated with the target network slice based at least in part on the indication of the prefix mapping information.

Aspect 13: The method of any of aspects 1 through 12, further comprising: receiving the control message as a non-access stratum message.

Aspect 14: The method of any of aspects 1 through 13, further comprising: transmitting the registration message to the selected IWF based at least in part on an internet protocol address associated with the IWF, wherein the access network node configuration indicates a respective internet protocol address associated with each IWF of the set of IWFs.

Aspect 15: A method for wireless communications at a network device, comprising: transmitting, to a UE, a control message comprising an access network node configuration, the access network node configuration indicating a set of IWFs and a set of network slices associated with the set of IWFs; and receiving, from the UE, a name resolution request message indicating a selected IWF based at least in part on the access network node configuration.

Aspect 16: The method of aspect 15, further comprising: transmitting, with the access network node configuration, a set of network slice simultaneous registration groups associated with each IWF of the set of IWFs.

Aspect 17: The method of any of aspects 15 through 16, further comprising: transmitting, to the UE, in response to the name resolution request message, an indication of an internet protocol address associated with the selected IWF.

Aspect 18: The method of any of aspects 15 through 17, further comprising: transmitting, with the access network node configuration, an indication to add a slicing prefix to the name resolution request message; and receiving, with the name resolution request message, a selected slicing prefix indicating a target network slice.

Aspect 19: The method of aspect 18, further comprising: transmitting, with the access network node configuration, an indication of prefix mapping information indicating a set of network slice simultaneous registration groups and an associated set of slicing prefixes, wherein the selected slicing prefix is based at least in part on the network slice simultaneous registration group associated with the selected slicing prefix being associated with the target network slice.

Aspect 20: The method of aspect 19, wherein transmitting the indication to add the slicing prefix to the name resolution request message comprises receiving the indication of prefix mapping information.

Aspect 21: The method of any of aspects 15 through 20, further comprising: transmitting, to the UE, an access and mobility message indicating a second set of network slices.

Aspect 22: The method of aspect 21, further comprising: transmitting, with the access and mobility message, an indication of prefix mapping information indicating a set of network slice simultaneous registration groups and an associated set of slicing prefixes; and receiving, with the name resolution request message, a selected slicing prefix indicating a network slice simultaneous registration group associated with a target network slice based at least in part on the indication of the prefix mapping information.

Aspect 23: The method of any of aspects 15 through 22, wherein the set of network slices may be used concurrently by the UE, and the set of IWFs are associated with the set of network slices that may be used concurrently.

Aspect 24: The method of aspect 23, further comprising: transmitting the control message as a non-access stratum message.

Aspect 25: An apparatus for wireless communications at a UE, comprising a processor; memory coupled with the processor; and instructions stored in the memory and executable by the processor to cause the apparatus to perform a method of any of aspects 1 through 14.

Aspect 26: An apparatus for wireless communications at a UE, comprising at least one means for performing a method of any of aspects 1 through 14.

Aspect 27: A non-transitory computer-readable medium storing code for wireless communications at a UE, the code comprising instructions executable by a processor to perform a method of any of aspects 1 through 14.

Aspect 28: An apparatus for wireless communications at a network device, comprising a processor; memory coupled with the processor; and instructions stored in the memory and executable by the processor to cause the apparatus to perform a method of any of aspects 15 through 24.

Aspect 29: An apparatus for wireless communications at a network device, comprising at least one means for performing a method of any of aspects 15 through 24.

Aspect 30: A non-transitory computer-readable medium storing code for wireless communications at a network device, the code comprising instructions executable by a processor to perform a method of any of aspects 15 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more” or “at least one of.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive a control message comprising an access network node configuration, the access network node configuration indicating a set of interworking functions and a set of network slices associated with the set of interworking functions;
select an interworking function from the set of interworking functions based at least in part on a target network slice being indicated in the access network node configuration as associated with the selected interworking function; and
transmit a registration message to the selected interworking function.

2. The apparatus of claim 1, wherein the instructions are further executable by the processor to cause the apparatus to:
select the interworking function based at least in part on the selected interworking function being associated with a network slice simultaneous registration group including the target network slice, wherein the access network node configuration indicates a set of network slice simultaneous registration groups associated with each interworking function of the set of interworking functions.

3. The apparatus of claim 2, wherein the instructions are further executable by the processor to cause the apparatus to:
select a second target network slice for concurrent use with the target network slice;
select, based at least in part on determining that the interworking function is not associated with the second target network slice, a second interworking function of the set of interworking functions, the second interworking function associated with the target network slice and the second target network slice; and
transmit a second registration message indicating the selected second interworking function.

4. The apparatus of claim 1, wherein the instructions are further executable by the processor to cause the apparatus to:
transmit a name resolution request message indicating the selected interworking function; and
receive, in response to the name resolution request message, an indication of an internet protocol address associated with the selected interworking function, wherein the registration message is based at least in part on the internet protocol address associated with the selected interworking function.

5. The apparatus of claim 1, wherein the instructions are further executable by the processor to cause the apparatus to:
receive, with the access network node configuration, an indication to add a slicing prefix to a name resolution request message; and
transmit, with the name resolution request message, a selected slicing prefix associated with the target network slice.

6. The apparatus of claim 5, wherein the instructions are further executable by the processor to cause the apparatus to:
receive, with the access network node configuration, an indication of prefix mapping information indicating a set of network slice simultaneous registration groups and an associated set of slicing prefixes; and
select the selected slicing prefix based at least in part on a network slice simultaneous registration group associated with the selected slicing prefix being associated with the target network slice.

7. The apparatus of claim 6, wherein the instructions executable by the processor to cause the apparatus to receive the indication to add the slicing prefix to the name resolution request message are further executable by the processor to cause the apparatus to receive the indication of prefix mapping information.

8. The apparatus of claim 1, wherein the instructions are further executable by the processor to cause the apparatus to:
receive a second control message indicating a second set of network slices; and
select the target network slice from the second set of network slices based at least in part on a target communication function.

9. The apparatus of claim 8, wherein the instructions executable by the processor to cause the apparatus to receive the second control message are further executable by the processor to cause the apparatus to:
receive the second control message in a mobility management message.

10. The apparatus of claim 9, wherein the instructions are further executable by the processor to cause the apparatus to:
receive, with the second control message, an indication of prefix mapping information indicating a set of network slice simultaneous registration groups and an associated set of slicing prefixes; and
transmit, with a name resolution request, a selected slicing prefix indicating a network slice simultaneous registration group associated with the target network slice based at least in part on the indication of the prefix mapping information.

11. The apparatus of claim 1, wherein the set of network slices may be used concurrently by the UE, and the set of interworking functions are associated with the set of network slices that may be used concurrently.

12. The apparatus of claim 1, wherein the instructions are further executable by the processor to cause the apparatus to:
receive, from a home network, an indication of access network node selection information for a roaming network, the access network node selection information indicating prefix mapping information indicating a set of network slice simultaneous registration groups and an associated set of slicing prefixes for the roaming network;
receive, from the roaming network, a second control message; and
transmit, with a name resolution request message, a selected slicing prefix indicating a network slice simultaneous registration group associated with the target network slice based at least in part on the indication of the prefix mapping information.

13. The apparatus of claim 1, wherein the instructions are further executable by the processor to cause the apparatus to:
receive the control message as a non-access stratum message.

14. The apparatus of claim 1, wherein the instructions are further executable by the processor to cause the apparatus to:
transmit the registration message to the selected interworking function based at least in part on an internet protocol address associated with the interworking function, wherein the access network node configuration indicates a respective internet protocol address associated with each interworking function of the set of interworking functions.

15. An apparatus for wireless communications at a network device, comprising:
a processor;
memory coupled with the processor; and
instructions stored in the memory and executable by the processor to cause the apparatus to:
transmit, to a user equipment (UE), a control message comprising an access network node configuration, the access network node configuration indicating a set of interworking functions and a set of network slices associated with the set of interworking functions; and
receive, from the UE, a name resolution request message indicating a selected interworking function based at least in part on the access network node configuration.

16. The apparatus of claim 15, wherein the instructions are further executable by the processor to cause the apparatus to:
transmit, with the access network node configuration, a set of network slice simultaneous registration groups associated with each interworking function of the set of interworking functions.

17. The apparatus of claim 15, wherein the instructions are further executable by the processor to cause the apparatus to:
transmit, to the UE, in response to the name resolution request message, an indication of an internet protocol address associated with the selected interworking function.

18. The apparatus of claim 15, wherein the instructions are further executable by the processor to cause the apparatus to:
transmit, with the access network node configuration, an indication to add a slicing prefix to the name resolution request message; and
receive, with the name resolution request message, a selected slicing prefix indicating a target network slice.

19. The apparatus of claim 18, wherein the instructions are further executable by the processor to cause the apparatus to:
transmit, with the access network node configuration, an indication of prefix mapping information indicating a set of network slice simultaneous registration groups and an associated set of slicing prefixes, wherein the selected slicing prefix is based at least in part on a network slice simultaneous registration group associated with the selected slicing prefix being associated with the target network slice.

20. The apparatus of claim 19, wherein the instructions executable by the processor to cause the apparatus to transmit the indication to add the slicing prefix to the name resolution request message are further executable by the processor to cause the apparatus to receive the indication of prefix mapping information.

21. The apparatus of claim 15, wherein the instructions are further executable by the processor to cause the apparatus to:
transmit, to the UE, an access and mobility message indicating a second set of network slices.

22. The apparatus of claim 21, wherein the instructions are further executable by the processor to cause the apparatus to:
transmit, with the access and mobility message, an indication of prefix mapping information indicating a set of network slice simultaneous registration groups and an associated set of slicing prefixes; and
receive, with the name resolution request message, a selected slicing prefix indicating a network slice simultaneous registration group associated with a target network slice based at least in part on the indication of the prefix mapping information.

23. The apparatus of claim 15, wherein the set of network slices may be used concurrently by the UE, and the set of interworking functions are associated with the set of network slices that may be used concurrently.

24. The apparatus of claim 23, wherein the instructions are further executable by the processor to cause the apparatus to:
transmit the control message as a non-access stratum message.

25. A method for wireless communications at a user equipment (UE), comprising:
receiving a control message comprising an access network node configuration, the access network node configuration indicating a set of interworking functions and a set of network slices associated with the set of interworking functions;
selecting an interworking function from the set of interworking functions based at least in part on a target network slice being indicated in the access network node configuration as associated with the selected interworking function; and
transmitting a registration message to the selected interworking function.

26. The method of claim 25, further comprising:
selecting the interworking function based at least in part on the selected interworking function being associated with a network slice simultaneous registration group including the target network slice, wherein the access network node configuration indicates a set of network slice simultaneous registration groups associated with each interworking function of the set of interworking functions.

27. The method of claim 26, further comprising:
selecting a second target network slice for concurrent use with the target network slice;
selecting, based at least in part on determining that the interworking function is not associated with the second target network slice, a second interworking function of the set of interworking functions, the second interworking function associated with the target network slice and the second target network slice; and
transmitting a second registration message indicating the selected second interworking function.

28. The method of claim 25, further comprising:
transmitting a name resolution request message indicating the selected interworking function; and
receiving, in response to the name resolution request message, an indication of an internet protocol address associated with the selected interworking function, wherein the registration message is based at least in part on the internet protocol address associated with the selected interworking function.

29. The method of claim 25, further comprising:
receiving, with the access network node configuration, an indication to add a slicing prefix to a name resolution request message; and
transmitting, with the name resolution request message, a selected slicing prefix associated with the target network slice.

30. A method for wireless communications at a network device, comprising:
transmitting, to a user equipment (UE), a control message comprising an access network node configuration, the access network node configuration indicating a set of interworking functions and a set of network slices associated with the set of interworking functions; and
receiving, from the UE, a name resolution request message indicating a selected interworking function based at least in part on the access network node configuration.
